(19) United States
(12) Patent Application Publication
(10) Pub. No.: US 2007/0183523 A1
(43) Pub. Date: Aug. 9, 2007

(54) METHOD AND APPARATUS FOR IMPROVING PACKET ERROR RATE PERFORMANCE USING BEAMFORMING TECHNIQUES

(75) Inventors: Chang-Soo Koo, Melville, NY (US); I-Tai Lu, Dix Hills, NY (US); Robert Lind Olesen, Huntington, NY (US); Hui-Yuan Teng, Forest Hills, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/617,017

(22) Filed: Dec. 28, 2006

Related U.S. Application Data
(60) Provisional application No. 60/771,636, filed on Feb. 9, 2006.
(60) Provisional application No. 60/772,463, filed on Feb. 10, 2006.

(51) Int. Cl. H04L 5/12

(52) U.S. Cl. 375/261

(57) ABSTRACT

A method and apparatus for implementing transmit and receive beamforming in an orthogonal frequency division modulation (OFDM) multiple-in multiple-out (MIMO) system. The OFDM MIMO system includes at least one transmitter and at least one receiver. A receive information vector is determined based upon channel estimates performed at the transmitter and the receiver.

### CROSS REFERENCE TO RELATED APPLICATIONS

This application claims the benefit of U.S. Provisional Application No. 60/771,636, filed Feb. 9, 2006, and U.S. Provisional Application No. 60/772,463, filed Feb. 10, 2006, both of which are incorporated by reference herein as if fully set forth.

### FIELD OF INVENTION

The present invention relates to wireless systems. More particularly, the present invention relates to a method and apparatus for improving packet error rate performance using transmit and receive beamforming techniques for IEEE 802.11n orthogonal frequency division modulation (OFDM) multiple-in multiple-out (MIMO) systems.

### BACKGROUND

Next generation standards, such as the IEEE 802.11n standard, third generation partnership project (3GPP) long term evolution (LTE) standard, and other advanced communication systems are considering the use of MIMO techniques that will enable solutions to achieve much higher throughputs. This is due to the fact that MIMO structures can provide multiple eigen-channels to facilitate the transmission of multiple spatial streams.

Since these eigen-channels usually have different channel gains, different coding rates and/or modulation schemes may need to be assigned to different spatial streams. In order to take full advantage of this feature, the MIMO transmitter and/or receiver need to have an accurate channel estimate to prevent inter-spatial stream-interference (ISSI) and to improve the packet error rate (PER). One way to achieve this is to utilize beamforming techniques.

In order to use beamforming techniques, typically the transmit side requires partial or full channel state information (CSI) and there are typical schemes to obtain the CSI in frequency division duplex (FDD) and time division duplex (TDD) systems. In FDD, the receiver can estimate the CSI from some type of received pilot symbols and feed back its CSI to the transmitter. In TDD, the receiver sends sounding pulses and the transmitter estimates the CSI by the channel reciprocity principle.

It would therefore be advantageous to provide a method and apparatus for optimally improving PER performance utilizing beamforming techniques.

### SUMMARY

A method and apparatus for implementing transmit and receive beamforming in an OFDM MIMO system. The OFDM MIMO system includes at least one transmitter and at least one receiver. A receive information vector is determined based upon channel estimates performed at the transmitter and the receiver.

### BRIEF DESCRIPTION OF THE DRAWINGS

A more detailed understanding of the invention may be had from the following description of a preferred embodiment, given by way of example and to be understood in conjunction with the accompanying drawings wherein:

FIG. 1 is a functional block diagram of a pair of WTRUs in a wireless communication system in accordance with the present invention;

FIG. 2 is a frequency domain functional block diagram of an OFDM MIMO system;

FIG. 3 is a flow diagram of a method for combining transmit and receive processing in accordance with the present invention;

FIG. 4 graphically illustrates four beamforming patterns formed by four receive antennas for four data streams utilizing a minimum mean square error (MMSE) approach;

FIG. 5 graphically illustrates four beamforming patterns formed by four transmit antennas for four data streams utilizing a singular value decomposition (SVD) approach;

FIG. 6 graphically illustrates four beamforming patterns formed by four receive antennas for four data streams utilizing an SVD approach;

FIG. 7 is a graphical representation of equal modulation data streams utilizing modulation and coding scheme (MCS) 12 and MCS 15;

FIG. 8 is a graphical representation of non-equal modulation data streams utilizing MCS 38 and MCS 41;

FIG. 9 is a graphical representation of equal modulation data streams utilizing MCS 28 and MCS 31; and

FIG. 10 is a graphical representation of non-equal modulation data streams utilizing MCS 100 and MCS 112.

### DETAILED DESCRIPTION OF THE PREFERRED EMBODIMENTS

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

The present invention is directed generally to combining transmit and receive beamforming processing to improve packet error rate (PER) performance. There are several different types of beamforming techniques or processing that may be implemented in a MIMO system. These beamforming techniques include transmit processing, receive processing, or combined transmit and receive processing. The data transmission is furnished by the multiplexing and de-multiplexing of multiple data streams which may have the same or different modulation and coding properties according to the assigned MCS value.

By using the estimated MIMO channel matrix for each sub-carrier and the singular value decomposition (SVD) of the estimated channel matrix at the transmitter and/or the receiver, several processing methods to achieve a better estimation of the transmitted signal may be utilized. In general, each processing method assigns data streams to eigen channels differently to reject the inter-spatial stream-interference (ISSI), and to transmit data with higher order modulations through stronger eigen channels.

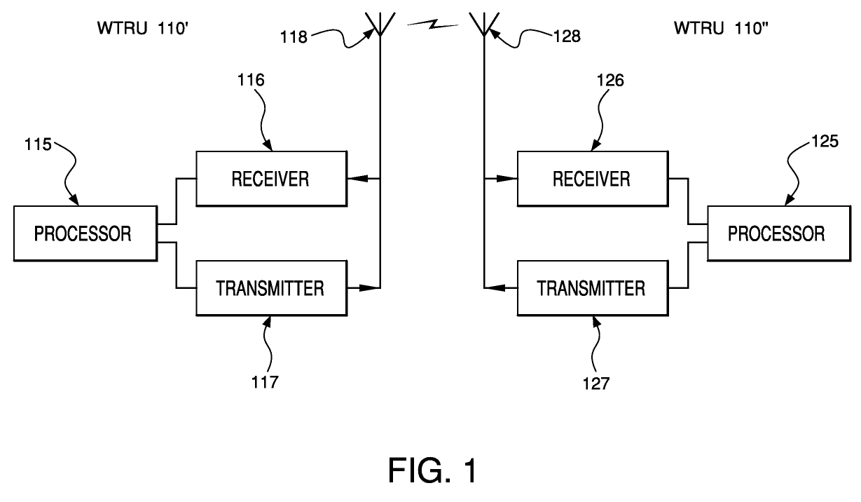

FIG. 1 is a functional block diagram of a pair of WTRUs 110, (designated as WTRU 110′ and WTRU 110″), which operate in a MIMO wireless communication system, configured in accordance with the present invention. As shown in FIG. 1, the WTRU 110′ and the WTRU 110″ are in wireless communication with one another, and are configured to perform transmit and receive beamforming processing in accordance with the present invention. Either the WTRU 110′ or the WTRU 110″ may act at any time as a transmitter, while the other operates as a receiver.

In addition to the components that may be found in a typical WTRU, the WTRU 110′ includes a processor 115, a receiver 116, a transmitter 117, and an antenna 118. The processor 115 is configured to perform transmit and receive beamforming processing in accordance with the present invention. The receiver 116 and the transmitter 117 are in communication with the processor 115. The antenna 118 is in communication with both the receiver 116 and the transmitter 117 to facilitate the transmission and reception of wireless data. Additionally, the receiver 116 may include a plurality of individual receivers, the transmitter 117 may include a plurality of individual transmitters, and the antenna 118 may include a plurality of individual antennas.

Similarly, in addition to the components that may be found in a typical WTRU, the WTRU 110″ includes a processor 125, a receiver 126, a transmitter 127, and an antenna 128. The processor 125 is configured to perform transmit and receive beamforming processing in accordance with the present invention. The receiver 126 and the transmitter 127 are in communication with the processor 125. The antenna 128 is in communication with both the receiver 126 and the transmitter 127 to facilitate the transmission and reception of wireless data. Additionally, the receiver 126 may include a plurality of individual receivers, the transmitter 127 may include a plurality of individual transmitters, and the antenna 128 may include a plurality of individual antennas.

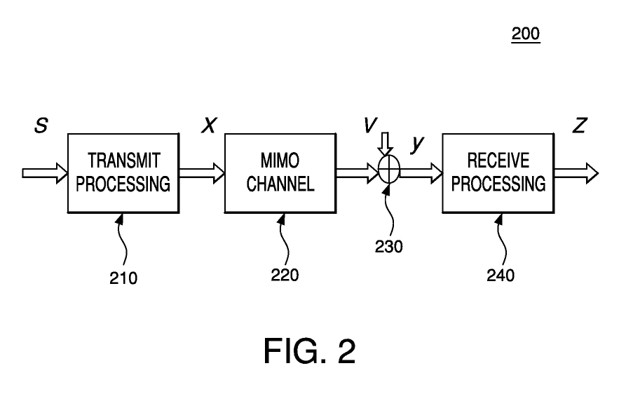

FIG. 2 is a frequency domain functional block diagram of an OFDM MIMO system 200. The OFDM MIMO system 200 includes a transmit processing functional block 210, a MIMO channel 220, an adder 230, and a receive processing functional block 240. The vector s denotes the transmit information vector before transmit processing by the transmit processing functional block 210. The vector x denotes the transmit receive signal vector after transmit processing that is transmitted over the MIMO channel 220. The vector v denotes the receive noise vector. The vector y denotes the receive signal vector before receive processing which has the noise vector v added to it at the adder 230, and the vector z denotes the receive information vector after receive processing by the receive processing functional block 240, but before any decision making.

In a preferred embodiment of the present invention, the vectors s, x, v, y and z are related by the following equations:

x=Ts; y=Hx+v; z=Ry and z=RHTs+Rv; Equations (1a; 1b; 1c; 1d)

where T is the transmit processing matrix, H is the MIMO channel matrix and R is the receive processing matrix. For purposes of example, it may be assumed that there are no intersymbol interferences because the cyclic prefix of an OFDM symbol is typically longer than the delay spreads of the MIMO channels. Additionally, the channel characteristics remain constant in any symbol period, which tends to result in no intercarrier interferences.

For purposes of example, if in a wireless communication system there are L data streams, M transmit antennas and N receive antennas with L≦M, N, y and v are two N×1 vectors, x is an M×1 vector, and s and z are two L×1 vectors. The dimensions of T, H and R are then M×L, N×M and L×N, respectively. Again for purposes of example, it may be assumed that L=M.

In practice, there are typically three main tasks in MIMO processing:

1. Estimating the covariance matrix Cᵥᵥ=E {vv^{H}} of noise υ.

2. Estimating the channel matrix H.

3. Estimating the information vector s.

In particular, estimating the information vector s aids in the development of various methods to choose T and R in order to make z as close to s as possible. If there is no noise, z should be equal to s. Accordingly, T and R should be chosen such that:

RHT=I; Equation (2)

where I is the identity matrix.

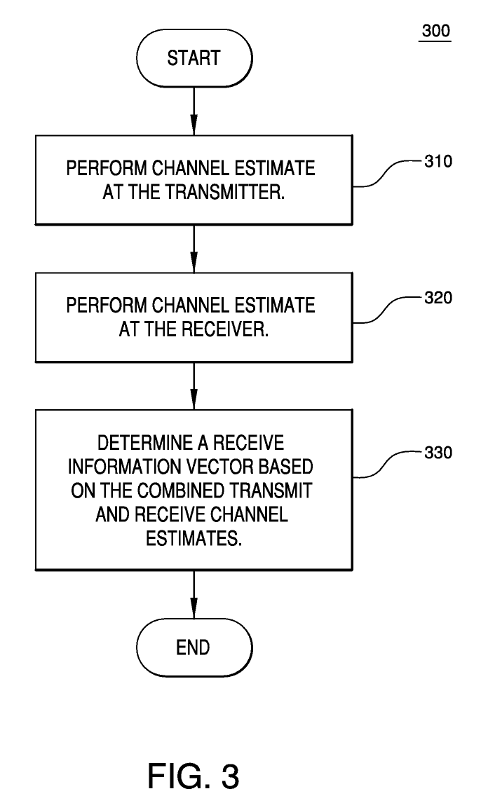

FIG. 3 is a flow diagram of a method 300 for combining transmit and receive processing, in accordance with the present invention. Although a more detailed description follows, generally, in step 310, a channel estimate at the transmitter is performed. A channel estimate at the receiver is performed (step 320), and the receive information vector is determined based upon the combined transmit and receive channel estimates (step 330).

In order to perform transmit and receive processing, two channel estimates are utilized, Ĥ, which is an estimate of the channel matrix H obtained at the transmitter, and \tilde{H}, which denotes an estimate of HT obtained at the receiver. Several processing approaches may be utilized in order to perform both transmit and receive processing.

For example, zero forcing at the transmitter (ZF Tx) may be utilized. For purposes of example, the receive processing matrix R may be assumed as R=I. In order to satisfy Equation (2), the transmit processing matrix T is chosen to be the inverse of H if H is a square matrix, or the pseudo inverse of H if H is not a square matrix. The transmit processing matrix can then be determined then in accordance with the following equation:

T=Ĥ⁻¹ or Ĥ^{-H}(ĤĤ^{H})⁻¹; Equation (3)

where the superscript H denotes Hermitian. The signal power then at the m^{th} transmit antenna may be then denoted as follows:

$$E \{ {\vert {x}_{m} \vert}^{2} \} = {\sum }_{n = 1}^{M} {\vert {T}_{mn} \vert}^{2} E \{ {\vert {s}_{n} \vert}^{2} \} = {\sum }_{n = 1}^{M} {\vert {T}_{mn} \vert}^{2} \frac{{P}_{t}}{M} ; \qquad \text{Equation (4)}$$

where Pₜ is the total transmit power and M is the number of transmit antennas. Tₘₙ is the mn^{th} element of the T matrix, xₘ is the m^{th} element of x, and sₙ is the n^{th} element of s.

Equation (4) therefore shows that

$$E \{ {\vert {x}_{m} \vert}^{2} \}$$

may be different from

$$E \{ {\vert {x}_{{m}^{′}} \vert}^{2} \}$$

if m≠m′. In other words, different transmit antennas transmit at different power levels to compensate the channel effect so that different data streams will have the same signal to noise ratios (SNRs) at the receiver. Therefore, no water filling process for data rate control is needed. In practice, however, power amplifiers employed at the transmitter have a limited dynamic range. Therefore, in order to keep the proper power ratio given in Equation (4) and to avoid nonlinear distortion, a transmitter can only transmit a portion of Pₜ which may not be a desirable outcome.

In one embodiment of the present invention, minimum mean square error (MMSE) or zero forcing at the receiver (ZF Rx) is performed.

Assuming for purposes of example that the transmit processing matrix T=I. In order to satisfy Equation (2), for the zero forcing approach, the receive processing matrix R is chosen to be the inverse of H if H is a square matrix, or the pseudo inverse of H if H is not a square matrix, as shown in the following equation:

R=Ĥ⁻¹ or (Ĥ^{H}Ĥ)⁻¹Ĥ^{H}. Equation (5a)

For the MMSE approach, the receiver processing matrix R may be chosen in accordance with the following equation:

R=[Ĥ^{H}Ĥ+Cᵥᵥ]⁻¹Ĥ^{H}. Equation (5b)

The noise power of the m^{th} data stream at the output of the receive processing may be determined by the following equation:

$$E \{ {\vert {\sum }_{n = 1}^{N} {R}_{mn} {v}_{n} \vert}^{2} \} = {\sum }_{n = 1}^{N} {\vert {R}_{mn} \vert}^{2} E \{ {\vert {v}_{n} \vert}^{2} \} = {σ}^{2} {\sum }_{n = 1}^{N} {\vert {R}_{mn} \vert}^{2} ; \qquad \text{Equation (6)}$$

where σ² is the noise variance at one of the receive antennas.

It can be seen in Equation (6) that

$${\sum }_{n = 1}^{N} {\vert {R}_{mn} \vert}^{2}$$

may be different from

$${\sum }_{n = 1}^{N} {\vert {R}_{{m}^{′} n} \vert}^{2}$$

if m≠m′. Rₘₙ is the mn^{th} element of the R matrix and υₙ is the n^{th} element of υ. In other words, different data streams may be loaded with different amounts of noise, and therefore may have different SNRs. SNRᵢ denotes the SNR of the i^{th} data stream sᵢ and SNRᵢ denotes the SNR of the j^{th} data stream sⱼ. SNRᵢ is typically larger than SNRⱼ if the noise for i is less than that for j. This applies throughout the rest of the description. For the fading multipath channel of a MIMO-OFDM system, the channel characteristics of subcarriers are typically different, such that the order of eigenvalue/beam strength (SNR) of subcarriers are different in terms of multiple beams. Therefore the data streams for MIMO are constructed by grouping the same order of eigenvalue/beam strength for all subcarriers. Accordingly, since the relation between SNRᵢ and SNRⱼ depends on the sub-carrier index or frequency, a water filling process for data rate control to compensate for uneven SNRs is difficult to implement.

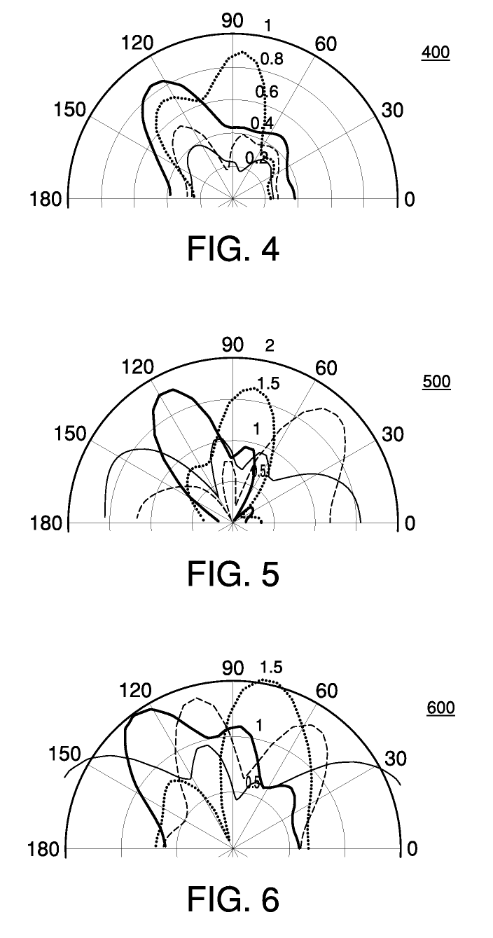

FIG. 4 graphically illustrates four beamforming patterns 400 formed by four receive antennas for four data streams utilizing the MMSE approach. It should be noted that the use of a single sub-carrier is depicted in FIG. 4. As shown in FIG. 4, three of the four beams have strongest power aiming around 130 degrees. Also, it can be seen that there is not much separation between the four beams. Accordingly, the reduction of inter-datastream interference may not necessarily be accomplished by beamforming at different angles. The estimation of the channel matrix, therefore, needs to be as accurate as possible.

Additionally, a singular value decomposition (SVD) approach may be utilized for both transmit and receive processing. For example, the SVD decompositions of H, H and H may be denoted as H=UΣV^{H}, Ĥ=Û\hat{Σ}\hat{V}^{H} and \tilde{H}=Ũ\tilde{Σ}\tilde{V}^{H}, respectively.

In a general form, the SVD approach assumes the following:

T=\hat{V} and R=\tilde{Σ}⁻¹Ũ^{H}. Equation (7)

If H≈Ĥ and Û≈Ũ, the receive information vector in Equation (1) becomes:

z=RHTs+Rv≈\tilde{Σ}Ũ^{H}(UΣV^{H})\hat{V}s+\tilde{Σ}⁻¹Ũ^{H}v≈s+\tilde{Σ}⁻¹Ũ^{H}v. Equation (8)

Ordinarily, the SNRs for different data streams in Equation (8) are not equal. However, since the transmit beamforming, or processing, has been performed, SNRᵢ is typically larger than SNRⱼ if i<j for all sub-carriers. Accordingly, a water filling process for data rate control to compensate uneven SNRs may be implemented to increase the spectral efficiency.

As may be evident in Equation (7), two SVD decompositions are required, one at the transmitter and the other at the receiver. Difficulty arises, however, because the U and V in an SVD decomposition may not be uniquely defined. For example, H={UD}Σ{D⁻¹V^{H}} is also a valid SVD decomposition for H if D is diagonal and unitary, and Σ is square. Accordingly, if Û is not approximately equal to Ũ, Equation (8) may not hold true.

Since Σ is uniquely determined in a SVD decomposition process, the following can be assumed in order to address the non-uniqueness problem in Equation (7):

T=\hat{Σ}^{-α}\hat{V} and R=\tilde{Σ}^{-(2-α)}\tilde{H}^{H}; Equation (9)

where 0≦α≦2.

The receive information vector in Equation (1) is then represented by the following equation:

z≈\tilde{Σ}^{-(2-α)}\tilde{H}^{H}(UΣV^{H})\hat{Σ}^{-α}\hat{V}s+\tilde{Σ}^{-(2-α)}\tilde{H}^{H}v≈s+\tilde{Σ}^{-(2-α)}\tilde{H}^{H}v. Equation (10)

Although Equation (9) requires that two SVDs be performed, only \tilde{Σ} from the second SVD at the receiver needs to be derived, which is uniquely determined. In a preferred embodiment α=0 may be chosen so that all transmit signals are of equal power.

Alternatively, the SVD approach may be modified by utilizing an MMSE receiver, in which case the following apply:

T=\hat{V} and R=[\tilde{H}^{H}\tilde{H}+Cᵥᵥ]⁻¹\tilde{H}^{H}. Equation (11)

All transmit signals depicted in Equation (11) are of equal power. However, there may be noise enhancement at the receiver for some data streams.

Performing transmit beamforming in Equations (9) and (11), the SNRᵢ of the i^{th} data stream is typically larger than SNRⱼ of the j^{th} data stream if i<j for all sub-carriers in both the SVD approach and the SVD-MMSE approach. Therefore, a water filling process for data rate control to compensate uneven SNRs can be implemented in either approach to increase the spectral efficiency.

FIG. 5 graphically illustrates four beamforming patterns 500 formed by four transmit antennas for four data streams utilizing the SVD approach and FIG. 6 graphically illustrates four beamforming patterns 600 formed by four receive antennas for four data streams utilizing the SVD approach.

Referring now to FIG. 5, the four beams are aiming at 150 degrees, 120 degrees, 80 degrees, and 45 degrees, respectively. Referring to FIG. 6, the four beams are aiming at 160/25 degrees, 126 degrees, 105/55 degrees, and 78 degrees, respectively. As depicted in FIGS. 5 and 6, there is substantial separation of the four beam at both the transmitter and the receiver. Accordingly, inter-datastream interference is reduced to a certain extent by beamforming at different angles. Furthermore, as can be seen by comparing FIG. 4 to FIGS. 5 and 6, combining the transmit and receive processing tends to result in better performance than either transmit processing or receive processing alone.

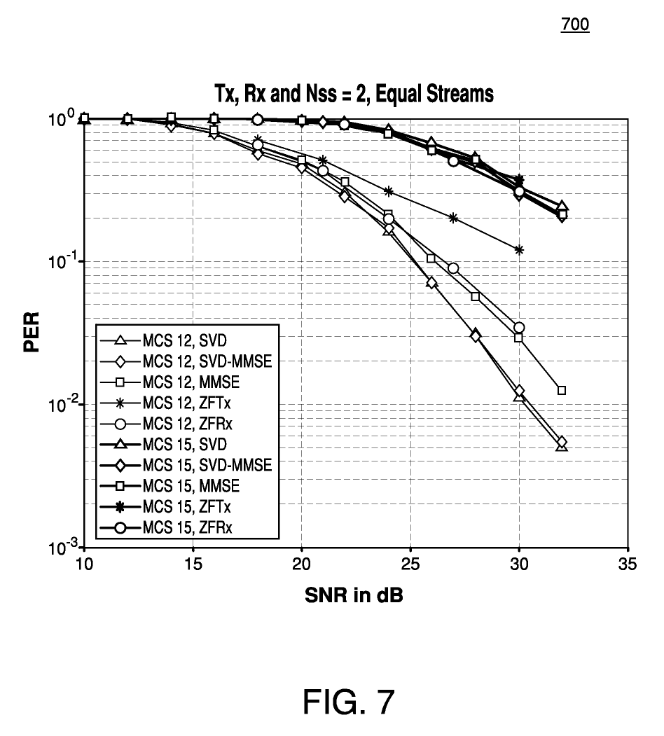

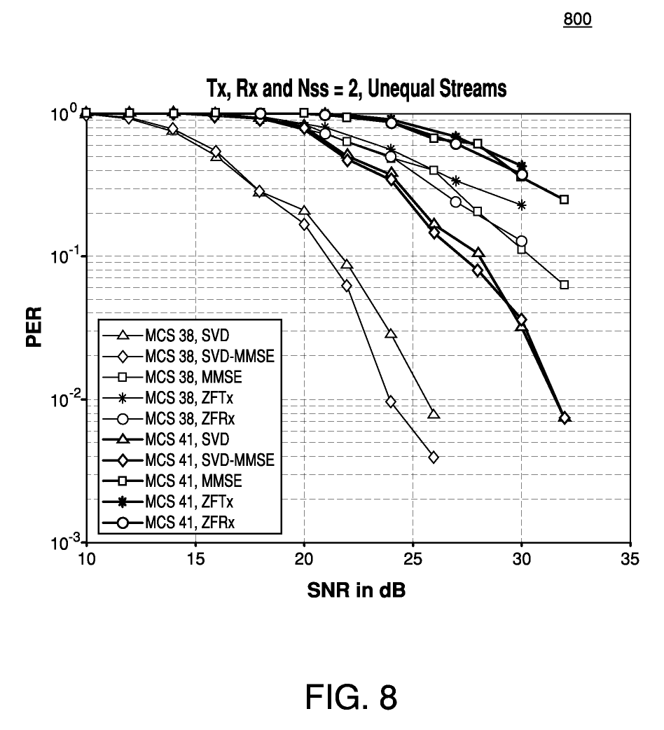

The following results may be realized utilizing a combination of transmit and receive beamforming having equal or un-equal data streams. FIG. 7 is a graphical representation 700 of equal modulation data streams utilizing modulation and coding scheme (MCS) 12 and MCS 15. FIG. 8 is a graphical representation 800 of non-equal modulation data streams utilizing MCS 38 and MCS 41. For example, in a MIMO system having 2 transmit antennas and 2 receive antennas, such as that proposed in the IEEE 802.11n system, the duration of an OFDM symbol is 3.2 μsec and the sub-carrier frequency spacing is 312.5 kHz. The total bandwidth is 20 MHz and the total number of sub-carriers is 64.

Among the 64 sub-carriers, 52 sub-carriers are typically employed for transmitting information data and 4 sub-carriers are typically utilized for transmitting pilot signals.

For purposes of example, two channel models are depicted in FIGS. 7 and 8. Also, two transmit antennas (Tx=2), two receive antennas (Rx=2), and two spatial streams (Nss=2) are utilized in the present example. The delay spread of the first channel is 90 nsec and the delay spread of the second channel is 400 nsec. The interval of cyclic prefix is 0.8 μsec. Each packet consists of 1000 information bytes in the present example. As shown in Table 1 below, four MCSs are listed:

TABLE 1
Modulation and Coding Schemes (MCS) with Tx = 2, Rx = 2,
and Nss = 2

| | MCS | | | |
|---|---|---|---|---|
| | 12 | 15 | 38 | 41 |
| Modulation 1 | 16-QAM | 64-QAM | 64-QAM | 256-QAM |
| Modulation 2 | 16-QAM | 64-QAM | QPSK | 16-QAM |
| Coding Rate | ¾ | ⅚ | ¾ | ¾ |
| Data rate | 78 Mbits/sec | 130 Mbits/ | 78 Mbits/sec | 117 Mbits/sec |
| | | sec | | |

As shown in Table 1, MCS 12 and MCS 15 have two equal-modulation data streams (16-QAM and 64-QAM, respectively), and MCS 38 and MCS 41 have two unequal-modulation data streams (64-QAM/QPSK and 256-QAM/16-QAM, respectively). MCS 15 has a higher data rate (130 Mbits/sec) than MCS 12 (78 Mbits/sec), and MCS 41 has a higher data rate (117 Mbits/sec) than MCS 38 (78 Mbits/sec). The data rate for MCS 12 and MCS 38 are the same. The coding rate for MCS 12, MCS 38 and MCS 41 are all ¾, while the coding rate for MCS 15 is ⅚.

The various processing methods described above were used to generate the results depicted in FIGS. 7 and 8. Additionally, both FIG. 7 and FIG. 8 depict results for the first channel, (i.e., delay spread of 90 nsec). The graphs 700 and 800 also show the results using either transmit or receive processing, (i.e., ZF Tx, ZF Rx and MMSE), or combining transmit and receive processing, (i.e., SVD and SVD-MMSE).

The results demonstrate that utilizing the combined transmit and receive processing achieves a better PER performance over using exclusively transmit or receive processing. However, the improvements for MCS 38 and MCS 41 are generally more significant than the improvements for MCS 12 and MCS 15. For example, at PER=0.2, the improvement is less than 1 dB for MCS 38, around 1 dB for MCS 12, around 7 dB for MCS 41, and around 8 dB for MCS 38.

This is mainly due to the fact that there are two eigen channels in the 2×2 MIMO system and the SNRs of these two eigen channels are usually different. In MCS 12 and MCS 15, the modulations for the two data streams are equal and the PER performance is limited by the weaker eigen channel. Therefore, using a better method such as SVD or SVD-MMSE may not improve the PER performance much, although it does provide improved performance.

However, in MCS 38 and MCS 41 schemes, the modulations for the two data streams are not equal. When the SVD or SVD-MMSE approach is employed, the lower QAM data stream may be assigned to the weaker eigen channel for all sub-carriers. Therefore, significant PER performance improvement is yielded.

Additionally, for transmit or receive processing, (i.e., ZF Tx, ZF Rx and MMSE), the PER performance of MCS 12 is better than that of MCS 38. This is mainly due to the fact that transmit or receive processing cannot conveniently assign the higher QAM data stream to the stronger eigen channel for all sub-carriers. Therefore, the unequal stream results are worse than the equal stream results.

For the two methods combining transmit and receive processings (i.e., SVD and SVD-MMSE), though, the PER performance of MCS 38 is much better than that of MCS 12. This is mainly due to the fact that SVD or SVD-MMSE typically assigns the higher QAM data stream to the stronger eigen channel for all sub-carriers. Therefore, the unequal stream results are significantly better than the equal stream results.

Although the same results essentially apply to the second channel, (i.e. delay spread of 400 nsec), it should be noted that that PER performance for the second channel may exceed that of the first channel for the same MCS if the same processing method is used. This is because the second channel has frequency selective fading and the first channel is essentially flat fading in the 20 MHz bandwidth. Therefore, frequency diversity gain in the second channel is larger than that in the first channel.

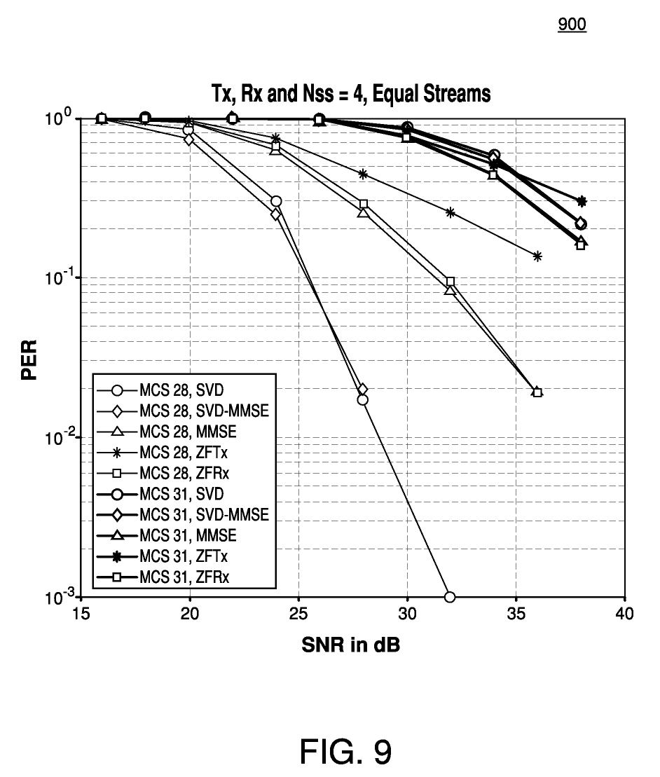

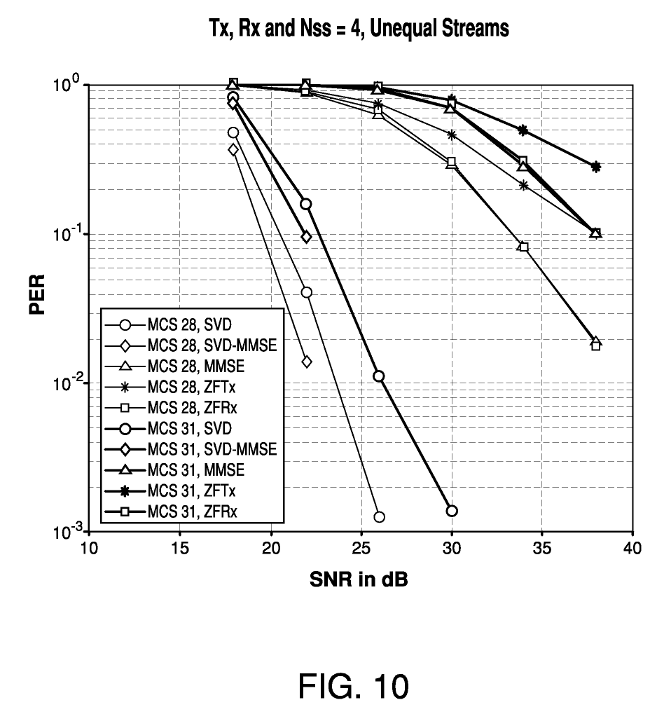

The results also apply to other MCS schemes. For example, two additional channel models are depicted in FIGS. 9 and 10. FIG. 9 is a graphical representation 900 of equal modulation data streams utilizing MCS 28 and MCS 31, and FIG. 10 is a graphical representation 1000 of non-equal modulation data streams utilizing MCS 100 and MCS 112.

Results from four transmit antennas (Tx=4), four receive antennas (Rx=4), and four spatial streams (Nss=4) are depicted in FIGS. 9 and 10. Table 2 below shows the configuration for the results determined if FIGS. 9 and 10:

TABLE 2
Modulation and Coding Schemes (MCS) with Tx = 4, Rx = 4,
and Nss = 4

| | MCS | | | |
|---|---|---|---|---|
| | 28 | 31 | 100 | 112 |
| Modulation 1 | 16-QAM | 64-QAM | 64-QAM | 256-QAM |
| Modulation 2 | 16-QAM | 64-QAM | 16-QAM | 64-QAM |
| Modulation 3 | 16-QAM | 64-QAM | 16-QAM | 16-QAM |
| Modulation 4 | 16-QAM | 64-QAM | QPSK | QPSK |
| Coding Rate | ¾ | ⅚ | ¾ | ¾ |
| Data rate | 156 Mbits/ | 260 Mbits/ | 156 Mbits/sec | 195 Mbits/sec |
| | sec | sec | | |

As depicted in Table 2, MCS 28 and MCS 31 employ equal-modulation data streams (16-QAM and 64-QAM, respectively), while MCS 100 and MCS 112 employ non-equal data streams (64-QAM/16-QAM/16-QAM/QPSK and 256-QAM/64-QAM/16-QAM/QPSK, respectively). MCS 31 has a higher data rate (260 Mbits/sec) than MCS 28 (156 Mbits/sec), and MCS 112 has a higher data rate (195 Mbits/sec) than MCS 100 (156 Mbits/sec). The data rate for MCS 28 and MCS 100 are the same. The coding rate for MCS 28, MCS 100 and MCS 112 are all ¾, while the coding rate for MCS 31 is ⅚.

In the equal stream case, the transmit processing, the receive processing and the combined transmit and receive processing have a similar PER performance. In the unequal stream case, the combined transmit and receive processing performed better, (e.g., 7˜10 dB better), than the transmit processing or the receive processing. This is due to the fact that eigen channels in MIMO systems typically have different channel gains for different sub-carriers. The combined transmit and receive processing methods can consistently assign data streams with higher order modulations to stronger eigen channels and data streams with lower order modulations to weaker eigen channels for all sub-carriers. However, the transmit only or receive only processing does not have this capability.

Comparing at the same data rate, unequal stream cases have a better PER performance than equal stream cases. Therefore, to achieve a higher throughput and a better PER performance for a given wireless propagation environment, unequal data streams (defined by a properly selected MCS) accompanied by the combined transmit and receive beamforming processing should be used.

Alternatively, an adaptive MCS selection implementation (or rate adaptation) is needed in attaining a better system performance.

The present invention may be implemented in any type of wireless communication system, as desired. By way of example, the present invention may be implemented in any type of IEEE 802 type system, smart antenna, OFDM MIMO, LTE or any other type of wireless communication system.

The features of the present invention may implemented by software, may be incorporated into an integrated circuit (IC), such as an application specific IC (ASIC) or be configured in a circuit comprising a multitude of interconnecting components. Additionally, the processors 115/125 of the WTRU 110′ and WTRU 110″, respectively, may be configured to perform any of the steps of the methods described above. The processors 115/125 may also utilize the receivers 116/126, transmitters 117/127, and antennas 118/128, respectively, to facilitate wirelessly receiving and transmitting data.

The performances of one transmit processing, two receive processing, and two combined transmit and receive processing techniques in the OFDM MIMO system specified by the proposed IEEE 802.11n WLAN standard have been investigated. The data transmission is furnished by the multiplexing and de-multiplexing of multiple data streams which may have the same or different modulation and coding properties according to the assigned MCS value. By using the estimated MIMO channel matrix for each sub-carrier at the transmitter and/or the receiver, different processing methods assign data streams to eigen channels differently to reject the inter-spatial stream-interference.

In the equal stream case, (e.g., MCS12 and MCS15), the transmit processing, the receive processing and the combined transmit and receive processing have a similar PER performance. In the unequal stream case, (e.g., MCS38 and MCS41), the combined transmit and receive processing perform 7110 dB better than the transmit processing or the receive processing. This is due to the fact that eigen channels in MIMO systems always have different channel gains for different sub-carriers. The combined transmit and receive processing methods can consistently assign data streams with higher order modulations to stronger eigen channels and data streams with lower order modulations to weaker eigen channels for all sub-carriers. But the transmit only or receive only processing does not have this capability.

Comparing at the same data rate, (e.g., 78M bits/sec), unequal stream cases, (e.g., MCS38) have a better PER performance than equal stream case, (e.g., MCS12). Therefore, to achieve a higher throughput and a better PER performance for a given wireless propagation environment, unequal data streams (defined by a properly selected MCS) accompanied by the combined transmit and receive beamforming processing have to be used. In practical implementations, adaptive MCS selection (or rate adaptation) is needed in attaining a better system performance.

The present invention may be implemented in any type of wireless communication system, as desired. By way of example, the present invention may be implemented in any type of IEEE 802 type system, OFDM MIMO, LTE or any other type of wireless communication system. The present invention may also be implemented on an integrated circuit, such as an application specific integrated circuit (ASIC), multiple integrated circuits, DSP, logical programmable gate array (LPGA), multiple LPGAs, discrete components, or a combination of integrated circuit(s), LPGA(s), and discrete component(s). Other implementations include a smart antenna device that uses one or more of the following: switched beamforming, antenna diversity or MIMO.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), a terminal, a base station, a radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method for transmit and receive beamforming in an orthogonal frequency division modulation (OFDM) multiple-in multiple-out (MIMO) system comprising at least one transmitter and at least one receiver, the method comprising:
performing a channel estimate at the transmitter;
performing a channel estimate at the receiver; and
determining a receive information vector based upon the channel estimates performed at the transmitter and the receiver.

2. The method of claim 1 wherein performing the channel estimate at the transmitter includes performing a singular value decomposition (SVD).

3. The method of claim 2, further comprising performing a minimum mean square error (MMSE) operation at the transmitter.

4. The method of claim 1 wherein performing the channel estimate at the receiver includes performing an SVD.

5. The method of claim 4, further comprising performing an MMSE operation at the receiver.

6. In an orthogonal frequency division modulation (OFDM) multiple-in multiple-out (MIMO) system comprising a plurality of wireless transmit/receive units (WTRUs), each WTRU comprising:
a receiver;
a transmitter; and
a processor in communication with the receiver and the transmitter, the processor configured to perform a transmit channel estimate on a signal transmitted by the transmitter, perform a receive channel estimate on a signal received by the receiver, and determine a received information vector based upon the transmit and receive channel estimates.

7. The WTRU of claim 6 wherein the processor is further configured to perform a singular value decomposition (SVD) on the transmit and receive channel estimates.

8. The WTRU of claim 7 wherein the processor is further configured to perform a minimum mean square error (MMSE) on the transmit and receive channel estimates.

9. The WTRU of claim 6, further comprising at least one antenna in communication with the transmitter and the receiver, wherein the antenna is configured to transmit a beamforming pattern received from the transmitter.

10. The WTRU of claim 9 wherein the antenna is configured to receive a beamforming pattern transmitted from another WTRU in the OFDM MIMO system.

11. The WTRU of claim 10 wherein the antenna includes a plurality of individual antennas.

12. The WTRU of claim 11 wherein the plurality of individual antennas are aimed at a plurality of angles.

13. The WTRU of claim 11 wherein the antenna includes four (4) individual antennas.

14. The WTRU of claim 13 wherein the four antennas are transmit antennas.

15. The WTRU of claim 14 wherein a first transmit antenna is aimed at a 150 degree angle, a second transmit antenna is aimed at a 120 degree angle, a third transmit antenna is aimed at an 80 degree angle, and a fourth transmit antenna is aimed at a 45 degree angle.

16. The WTRU of claim 13 wherein the four antennas are receive antennas.

17. The WTRU of claim 16 wherein a first receive antenna is aimed at a 160/25 degree angle, a second receive antenna is aimed at a 126 degree angle, a third receive antenna is aimed at a 105/55 degree angle, and a fourth receive antenna is aimed at a 78 degree angle.

18. The WTRU of claim 6 wherein the processor employs any one of the following modulation and coding schemes (MCS) for transmission: MCS 12, MCS 15, MCS 38, MCS 41, MCS 28, MCS 31, MCS 100, and MCS 112.

19. The WTRU of claim 18 wherein the processor employs any one of the following modulation schemes: Quadrature Amplitude Modulation (QAM) and Quadrature Phase Shift Keying (QPSK).

20. The WTRU of claim 19 wherein QAM includes 16-QAM, 64-QAM, or 256-QAM.

21. The WTRU of claim 20 wherein the processor employs any one of the following coding rates: ¾ and ⅚.

22. The WTRU of claim 21 wherein the processor employs any one of the following data rates: 78 MBPS, 130 MBPS, 117 MBPS, 156 MBPS, 195 MBPS, and 260 MBPS.

23. The WTRU of claim 22 wherein MCS 12 includes 16-QAM modulation, ¾ coding rate, and a data rate of 78 MBPS.

24. The WTRU of claim 22 wherein MCS 15 includes 64-QAM modulation, ⅚ coding rate, and a data rate of 130 MBPS.

25. The WTRU of claim 22 wherein MCS 38 includes 64-QAM modulation, ¾ coding rate, and a data rate of 78 MBPS.

26. The WTRU of claim 22 MCS 38 includes QPSK modulation, ¾ coding rate, and a data rate of 78 MBPS.

27. The WTRU of claim 22 wherein MCS 41 includes 256-QAM modulation, ¾ coding rate, and a data rate of 117 MBPS.

28. The WTRU of claim 22 wherein MCS 41 includes 16-QAM modulation, ¾ coding rate, and a data rate of 117 MBPS.

29. The WTRU of claim 22 wherein MCS 28 includes 16-QAM modulation, ¾ coding rate, and a data rate of 156 MBPS.

30. The WTRU of claim 22 wherein MCS 31 includes 64-QAM modulation, ⅚ coding rate, and a data rate of 260 MBPS.

31. The WTRU of claim 22 wherein MCS 100 includes 64-QAM modulation, ¾ coding rate, and a data rate of 156 MBPS.

32. The WTRU of claim 22 wherein MCS 100 includes 16-QAM modulation, ¾ coding rate, and a data rate of 156 MBPS.

33. The WTRU of claim 22 wherein MCS 100 includes QPSK modulation, ¾ coding rate, and a data rate of 156 MBPS.

34. The WTRU of claim 22 wherein MCS 112 includes 64-QAM modulation, ¾ coding rate, and a data rate of 195 MBPS.

35. The WTRU of claim 22 wherein MCS 112 includes 256-QAM modulation, ¾ coding rate, and a data rate of 195 MBPS.

36. The WTRU of claim 22 wherein MCS 112 includes 16-QAM modulation, ¾ coding rate, and a data rate of 195 MBPS.

37. The WTRU of claim 22 wherein MCS 112 includes QPSK modulation, ¾ coding rate, and a data rate of 195 MBPS.

38. In an orthogonal frequency division modulation (OFDM) multiple-in multiple-out (MIMO) system comprising a plurality of wireless transmit/receive units (WTRUs), each WTRU including an integrated circuit (IC), the IC comprising:
a receiver;
a transmitter; and
a processor in communication with the receiver and the transmitter, the processor configured to perform a transmit channel estimate on a signal transmitted by the transmitter, perform a receive channel estimate on a signal received by the receiver, and determine a received information vector based upon the transmit and receive channel estimates.

39. The IC of claim 38 wherein the processor is further configured to perform a singular value decomposition (SVD) on the transmit and receive channel estimates.

40. The IC of claim 39 wherein the processor is further configured to perform a minimum mean square error (MMSE) on the transmit and receive channel estimates.
